(19) United States
(12) Patent Application Publication
(10) Pub. No.: US 2026/0110914 A1
(43) Pub. Date: Apr. 23, 2026

(54) COAXIAL AND OFF-AXIS COMPATIBLE ILLUMINATION DEVICE AND ILLUMINATION METHOD

(71) Applicant: THE INSTITUTE OF OPTICS AND ELECTRONICS, THE CHINESE ACADEMY OF SCIENCES, Chengdu, Sichuan (CN)

(72) Inventors: Xiangang Luo, Chengdu, Sichuan (CN); Hongyu Shao, Chengdu, Sichuan (CN); Lixin Zhao, Chengdu, Sichuan (CN); Yu He, Chengdu, Sichuan (CN); Changtao Wang, Chengdu, Sichuan (CN); Yanqin Wang, Chengdu, Sichuan (CN); Sihan Wu, Chengdu, Sichuan (CN)

(21) Appl. No.: 19/143,909

(22) PCT Filed: Dec. 29, 2022
(86) PCT No.: PCT/CN2022/143397

§ 371 Date: Jun. 27, 2025

(51) Int. Cl. G02B 27/18; G02B 26/02; G02B 27/09; G02B 27/30

(52) U.S. Cl. CPC G02B 27/18; G02B 26/02; G02B 27/0955; G02B 27/0977; G02B 27/0994; G02B 27/30

(57) ABSTRACT

An illumination device compatible with both coaxial and off-axis configurations, comprising: a coaxial illumination unit; multipole off-axis illumination units; a substrate, configured to mount the coaxial illumination unit and the multipole off-axis illumination units; and a motion mechanism, configured to drive the off-axis illumination units to move backward and forward, so as to accommodate gratings of different sizes and pattern periods, thereby achieving illumination with varying numerical apertures.

### TECHNICAL FIELD

The present disclosure relates to the technical field of optical illumination, and specifically to an illumination device compatible with both coaxial and off-axis configurations and an illumination method.

### BACKGROUND ART

According to whether an illumination device is coaxial with a projection lens, illumination devices can be classified into two types: coaxial illumination and off-axis illumination. The coaxial illumination herein means that an axis of light beams incident on a patterning device is coaxial with the projection lens, with a relatively simple structure thereof. Projection exposure systems with relaxed resolution requirements, coaxial illumination devices are generally used. The off-axis illumination means that an axis of light beams incident on a patterning device is not coaxial with the projection lens, thereby improving resolution of projection exposure systems. Numerical aperture (NA) of optical systems is a dimensionless number for measuring an angular range of light that can be collected by the system: NA=n·sin α. Optical imaging system resolution is R=k₁λ/NA. When process coefficient k₁ and incident wavelength λ are unchanged, the larger the NA is, the smaller the resolvable light spot is.

In conventional illumination devices, in order to improve illumination resolution, the NA value of the illumination devices needs to be improved. The NA value of a set of illumination device is usually unchanged, and changing the NA value needs replacing optical devices with different NAs. Therefore, it is impossible to achieve exposures with different resolutions through one set of illumination device. Moreover, an increased numerical aperture will bring about considerable difficulties to design and processing, and particularly when the numerical aperture NA is larger than 0.6, the difficulty to design and process the objective is increased every time the NA is increased by 0.05.

### SUMMARY

### (I) Technical Problem to be Solved

Regarding the above problems, the present disclosure provides an illumination device compatible with both coaxial and off-axis configurations and an illumination method, for solving technical problems in the conventional illumination devices, such as the difficulty in achieving exposures with different resolutions and high device processing complexity.

### (II) Technical Solution

In one aspect, the present disclosure provides an illumination device compatible with both coaxial and off-axis configurations, including: a coaxial illumination unit; multipole off-axis illumination units; a substrate, configured to mount the coaxial illumination unit and the multipole off-axis illumination units; and a motion mechanism, configured to drive the off-axis illumination units to move backward and forward, so as to accommodate gratings of different sizes and pattern periods, thereby achieving illumination with varying numerical apertures.

Further, the coaxial illumination unit includes, along an optical path in sequence, a first optical fiber beam expander assembly, a first integrator mirror, a first condenser lens assembly, a total internal reflection mirror, a digital micromirror device and a projection lens assembly, where light emitted from an optical fiber is expanded by the first optical fiber beam expander assembly, homogenized by the first integrator mirror and the first condenser lens assembly, turned by the total internal reflection mirror, to uniformly illuminate the digital micromirror device, intensity-modulated by the digital micromirror device, and then imaged onto a patterned plane by the projection lens assembly.

Further, the off-axis illumination unit includes, along an optical path in sequence, an off-axis illumination shutter, a second optical fiber beam expander assembly, a second integrator mirror, a second condenser lens assembly, a first reflector assembly, and a second reflector assembly, where light emitted from an optical fiber is expanded by the second optical fiber beam expander assembly, homogenized by the second integrator mirror and the second condenser lens assembly, turned by the first reflector assembly and the second reflector assembly in sequence and then imaged onto a patterned plane; and the off-axis illumination shutter is configured to control the off-axis illumination unit's optical path's on/off state.

Further, the multipole off-axis illumination units include a single-pole illumination unit, dipole illumination unit or quadrupole illumination unit, where when the N is multipoles, the multipole off-axis illumination units are uniformly distributed around the periphery of the coaxial illumination unit.

Further, the motion mechanism includes: a stage, configured to fix the off-axis illumination units; a guide rail, fixed on the substrate; and a motor, configured to push the stage to slide backward and forward on the guide rail.

Further, an illumination field of the digital micromirror device is provided at a defocused position.

In the other aspect, the present disclosure provides a method for illuminating according to the preceding illumination device compatible with both coaxial and off-axis configurations, including: S1, expanding light emitted from an optical fiber by a first optical fiber beam expander assembly, homogenizing expanded light by a first integrator mirror and a first condenser lens assembly, and turning homogenized light by a total internal reflection mirror, to uniformly illuminate the digital micromirror device; performing light intensity modulation by the digital micromirror device, and forming an image on a patterned plane by a projection lens assembly, so as to realize coaxial illumination; S2, expanding the light emitted from the optical fiber by a second optical fiber beam expander assembly, homogenizing expanded light by a second integrator mirror and a second condenser lens assembly, turning homogenized light by a first reflector assembly and a second reflector assembly in sequence, and then forming an image on the patterned plane, so as to realize off-axis illumination, where switching between the coaxial illumination and the off-axis illumination is achieved by the digital micromirror device and an off-axis illumination shutter.

Further, S1 also includes: performing grayscale modulation control by the digital micromirror device, so as to achieve any illumination intensity distribution across an illumination field.

Further, S2 also includes: replacing gratings of different sizes and pattern periods, and driving the off-axis illumination unit to move backward and forward by the motion mechanism, so as to achieve the off-axis illumination with varying numerical apertures.

Further, S2 also includes: overlapping light by multiple poles of the off-axis illumination units, and selecting a region where the light is overlapped as an illumination field.

### (III) Beneficial Effects

The illumination device compatible with both coaxial and off-axis configurations and the method for illuminating of the present disclosure realizes the coaxial illumination by the coaxial illumination unit, realizes the off-axis illumination by the off-axis illumination unit, and achieves the switching between the coaxial illumination and the off-axis illumination by the digital micromirror device in the coaxial illumination unit and the off-axis illumination shutter in the off-axis illumination unit. Further, by replacing the gratings of different sizes and pattern periods, and driving the off-axis illumination units to move backward and forward by the motion mechanism, the off-axis illumination with different numerical apertures is realized.

### BRIEF DESCRIPTION OF DRAWINGS

FIG. 1 schematically shows a structural schematic view of an illumination device compatible with both coaxial and off-axis configurations according to embodiments of the present disclosure;

FIG. 2 schematically shows a structural schematic view of a coaxial illumination unit according to embodiments of the present disclosure;

FIG. 3 schematically shows a structural schematic view of an off-axis illumination unit according to embodiments of the present disclosure;

FIG. 4 schematically shows a structural schematic view of a motion mechanism in the off-axis illumination unit according to embodiments of the present disclosure;

FIG. 5 schematically shows a simulated schematic view of removing a grid effect by defocusing according to embodiments of the present disclosure;

FIG. 6 schematically shows a result diagram of DMD grid experiment according to embodiments of the present disclosure;

FIG. 7 schematically shows a schematic diagram of an NA regulation principle of the off-axis illumination unit according to embodiments of the present disclosure;

FIG. 8 schematically shows a schematic diagram of a principle of illumination field changes with changes in NA according to embodiments of the present disclosure; and

FIG. 9 schematically shows an illumination schematic view of convergence of quadrupole illumination unit of light spots according to embodiments of the present disclosure.

### ILLUSTRATION OF REFERENCE SIGNS

1, coaxial illumination unit; 1-1, first optical fiber beam expander assembly; 1-2, first integrator mirror; 1-3, first condenser lens assembly; 1-4, total internal reflection mirror; 1-5, digital micromirror device; 1-6, projection lens assembly; 2, off-axis illumination unit; 2-1, off-axis illumination shutter; 2-2, second optical fiber beam expander assembly; 2-3, second integrator mirror; 2-4, motion mechanism; 2-4-1, stage; 2-4-2, guide rail; 2-4-3, motor; 2-5, second condenser lens assembly; 2-6, first reflector assembly; 2-7, second reflector assembly; 2-8, substrate.

### DETAILED DESCRIPTION OF EMBODIMENTS

In order to make objectives, technical solutions and advantages of the present disclosure more clear and understandable, the present disclosure is further described in detail below in conjunction with embodiments with reference to drawings.

The terms used herein are merely for the purpose of describing the embodiments, and are not intended to limit the present disclosure. The terms “include”, “contain”, etc. used herein indicate existence of the features, steps, operations and/or components, but do not exclude existence or addition of one or more other features, steps, operations, or components.

It should be noted that if the embodiments in the present disclosure involve a directional indication, the directional indication is only intended to explain a relative positional relationship between various components in a particular posture, movement condition, etc. If the particular posture changes, the directional indication will also change accordingly.

The ordinals used in the description and the claims, such as “first”, “second”, and “third”, are used to modify corresponding elements, while they themselves do not mean or represent any order of the elements, or represent sequence of one element with another, or sequence of steps in a manufacturing method. These ordinals are only used to clearly distinguish an element with a certain name from another element with the same name.

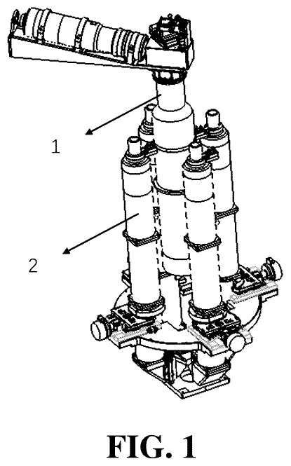

The present disclosure provides an illumination device compatible with both coaxial and off-axis configurations, with reference to FIG. 1, including: a coaxial illumination unit 1; multipole off-axis illumination units 2; a substrate 2-8, configured to mount the coaxial illumination unit 1 and the multipole off-axis illumination units 2; and a motion mechanism 2-4, configured to drive the off-axis illumination units 2 to move backward and forward, so as to accommodate gratings of different sizes and pattern periods, thereby realizing illumination with different NAs.

The illumination device mainly includes two parts, i.e., the coaxial illumination unit 1 and the off-axis illumination units 2, where the coaxial illumination unit 1 is used for realizing coaxial illumination, the off-axis illumination units 2 are used for realizing off-axis illumination, and switching between the coaxial illumination and the off-axis illumination can be achieved. By replacing the gratings of different sizes and pattern periods, and driving the off-axis illumination units 2 to move backward and forward by the motion mechanism, the off-axis illumination with different numerical apertures is realized.

The coaxial illumination unit 1 and the off-axis illumination units 2 are mounted on the substrate 2-8. Multipole off-axis illumination units 2 can be provided on the substrate 2-8 as needed, and by forming an illumination field through multiple poles of off-axis light spot projection within a target area, a problem of non-uniformity of a single-pole off-axis illumination field is solved. The motion mechanism drives a single-pole off-axis illumination unit 2 to move backward and forward to accommodate the gratings of different sizes and pattern periods, further realizing that the illumination device with different NAs is provided in a designated region, meeting a functional requirement for a higher illumination NA during off-axis illumination, and achieving switching between different functions.

Based on the above embodiments, the coaxial illumination unit 1 includes, along an optical path in sequence, a first optical fiber beam expander assembly 1-1, a first integrator mirror 1-2, a first condenser lens assembly 1-3, a total internal reflection mirror (TIR) 1-4, a digital micromirror device (DMD) 1-5 and a projection lens assembly 1-6. Herein, light emitted from an optical fiber is expanded by the first optical fiber beam expander assembly 1-1, homogenized by the first integrator mirror 1-2 and the first condenser lens assembly 1-3, turned by the total internal reflection mirror 1-4 to uniformly illuminate the digital micromirror device 1-5, intensity-modulated by the digital micromirror device 1-5, and then imaged onto a patterned plane by the projection lens assembly 1-6.

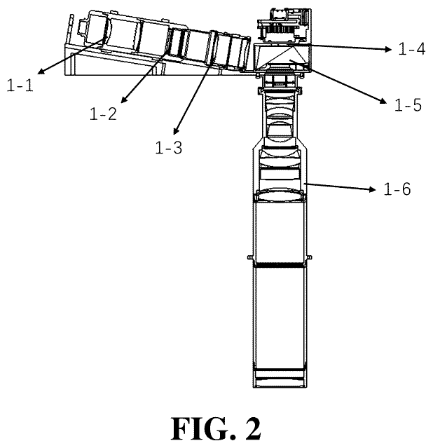

A structural schematic view of the coaxial illumination unit 1 is as shown in FIG. 2. The light emitted from the optical fiber is expanded by the first optical fiber beam expander assembly 1-1, and then is homogenized by the first integrator mirror 1-2 and the first condenser lens assembly 1-3; homogenized light is deflected by a TIR prism to uniformly illuminate a DMD surface, and then imaged by the projection lens assembly 1-6 onto the patterned plane. The coaxial illumination unit 1 further includes a lens barrel for mounting the above elements.

On the basis of the above embodiments, each off-axis illumination unit 2 includes, along an optical path in sequence, an off-axis illumination shutter 2-1, a second optical fiber beam expander assembly 2-2, a second integrator mirror 2-3, a second condenser lens assembly 2-5, a first reflector assembly 2-6 and a second reflector assembly 2-7. Herein, the light emitted from the optical fiber is expanded by the second optical fiber beam expander assembly 2-2, homogenized by the second integrator mirror 2-3 and the second condenser lens assembly 2-5, turned by the first reflector assembly 2-6 and the second reflector assembly 2-7 in sequence and then imaged onto the patterned plane. The off-axis illumination shutter 2-1 is configured to control the off-axis illumination unit's optical path's on/off state.

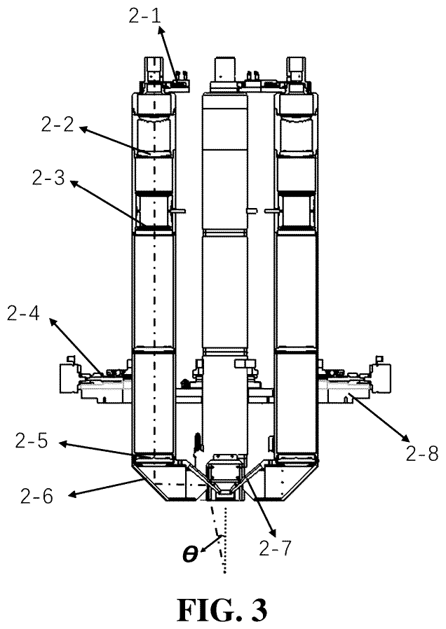

A structural schematic view of the off-axis illumination units 2 is as shown in FIG. 3. The light emitted from the optical fiber, after being expanded by the second optical fiber beam expander assembly 2-2, is homogenized by the second integrator mirror 2-3 and the second condenser lens assembly 2-5; homogenized light is deflected by the first reflector assembly 2-6 and the second reflector assembly 2-7 in sequence, to uniformly illuminate the patterned plane (not shown in the drawing). The optical path is as shown by dotted lines in FIG. 3, and an included angle between light incident on the patterned plane and a normal of the patterned plane is θ.

The illumination device compatible with both coaxial and off-axis configurations and illumination method in the present disclosure achieve the switching between the coaxial illumination and the off-axis illumination using the DMD in the coaxial illumination unit 1 and the off-axis illumination shutter 2-1 in the off-axis illumination unit. The device is compact in mechanical structure, and simple and convenient.

On the basis of the above embodiments, the multipole off-axis illumination units include a single pole illumination unit, dipole illumination unit or quadrupole illumination unit. Herein, when the N is multipoles, the multipole off-axis illumination units 2 are uniformly distributed around the periphery of the coaxial illumination unit 1.

As shown in FIG. 1, the off-axis illumination units 2 are quadrupole illumination unit, and the quadrupole off-axis illumination units 2 are uniformly distributed at the periphery of the coaxial illumination unit 1. Certainly, the off-axis illumination units 2 can also be of a single-pole illumination unit, dipole illumination unit, etc., which can be selected according to the number of poles of the off-axis illumination units actually required.

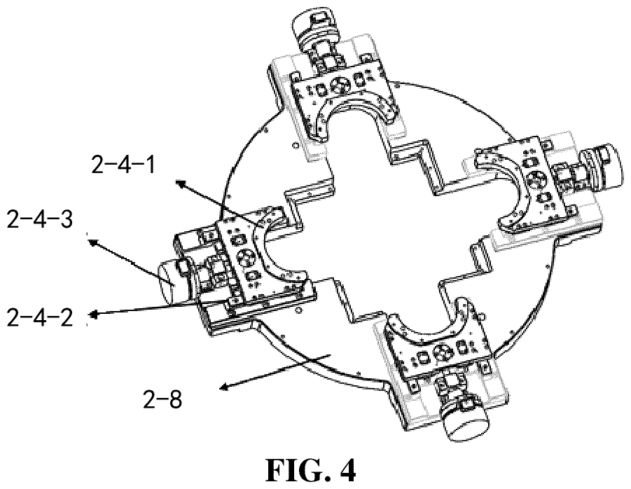

On the basis of the above embodiments, as shown in FIG. 4, the motion mechanism 2-4 includes: a stage 2-4-1 configured to fix the off-axis illumination units 2; a guide rail 2-4-2 fixed on the substrate 2-8; and a motor 2-4-3 configured to push the stage 2-4-1 to slide backward and forward on the guide rail 2-4-2.

First, the motor 2-4-3 is energized to operate, the motor 2-4-3 drives the stage 2-4-1 to move backward and forward on the guide rail 2-4-2, the stage 2-4-1 in turn drives a single-pole off-axis illumination unit 2 to move backward and forward, and further with different NAs, an illumination field can be formed in a designated region of the patterned plane.

Based on the above embodiments, an illumination field of the digital micromirror device 1-5 is provided at a defocused position.

The DMD is an array structure composed of micromirror units. The micromirror units have a size of about 14 μm, an array typically composed of 0.5 to 2 million micromirror units is used, with gaps of approximately 1 μm between adjacent units, thus producing a clear grid effect on a focal plane of the DMD, and causing non-uniform illumination.

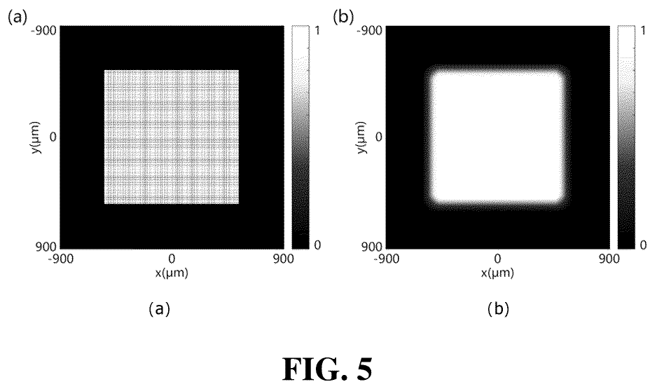

With reference to (a) of FIG. 5, a gap of 0.8 μm-1 μm exists between adjacent units in a DMD, while at higher resolutions, the gap will be distinctly displayed on the focal plane in the illumination field, thereby generating a relatively clear grid effect and causing non-uniform illumination, which should be avoided in the design of illumination devices. Therefore, the present disclosure suppresses the grid effect by providing the illumination field at the defocused position.

Assume that illumination light output by all micromirrors in the DMD has an equal intensity on the focal plane, a light field intensity in a gap region between adjacent micromirrors is 0, and on a plane perpendicular to an optical axis at 1 mm from defocused position, the distribution of the light field intensity of the plane is obtained through PSF simulation, as shown in (b) of FIG. 5. Apparently, by selecting the light field at the defocused position as an illumination field of the coaxial illumination unit 1, a “mosaic” effect caused by gaps between micromirrors in the DMD is eliminated, thus enabling light field intensity distribution to be continuous and smooth. A specific defocused amount can be deduced backward through a uniform coefficient over a desired illumination field.

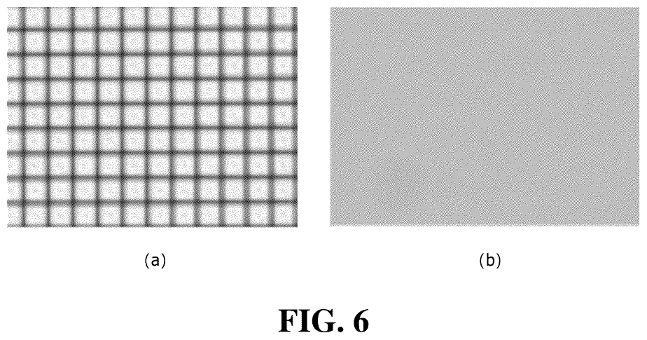

Specifically, with reference to FIG. 6, an experiment is conducted to eliminate a DMD grid effect in the coaxial illumination unit through defocusing, and light field distributions are acquired under in-focus and defocused conditions, respectively. As shown in (a) of FIG. 6, a grid pattern can be seen apparently at the focal plane, and a uniformly distributed light field can be obtained after defocusing by 1 mm. As shown in (b) of FIG. 6, it is verified that defocusing can realize homogenization of the light field.

The present disclosure further provides a method for illuminating according to the preceding illumination device compatible with both coaxial and off-axis configurations, including: S1, expanding light emitted from an optical fiber by a first optical fiber beam expander assembly 1-1, homogenizing expanded light by a first integrator mirror 1-2 and a first condenser lens assembly 1-3, and turning homogenized light by a total internal reflection mirror 1-4, to uniformly illuminate a digital micromirror device 1-5; performing light intensity modulation by the digital micromirror device 1-5, and forming an image on a patterned plane by a projection lens assembly 1-6, so as to realize coaxial illumination; S2, expanding the light emitted from the optical fiber by a second optical fiber beam expander assembly 2-2, homogenizing expanded light by a second integrator mirror 2-3 and a second condenser lens assembly 2-5, turning homogenized light by a first reflector assembly 2-6 and a second reflector assembly 2-7 in sequence, and then forming an image on the patterned plane, so as to realize off-axis illumination. Herein, switching between the coaxial illumination and the off-axis illumination is achieved by the digital micromirror device 1-5 and an off-axis illumination shutter 2-1.

Using the above illumination device compatible with both coaxial and off-axis configurations for illumination, the present disclosure can achieve the switching between the coaxial illumination and the off-axis illumination by a DMD of a coaxial illumination unit and the off-axis illumination shutter of an off-axis illumination unit. By replacing gratings of different sizes and pattern periods, and combining a displacement motion mechanism, off-axis illumination with different NAs is realized in a designated illumination field, and the switching between modes of the coaxial illumination and the off-axis illumination with different NAs is taken into account.

Based on the above embodiments, S1 further includes: performing grayscale modulation control by the digital micromirror device 1-5, so as to achieve any illumination intensity distribution across an illumination field.

When the desired illumination field exhibits non-uniform intensity distribution with high-intensity in some regions and low-intensity in others, that is, when the required illumination field is a non-uniform light field, a corresponding micromirror array region in the digital micromirror device 1-5 can be adjusted to an off state at positions where a low-intensity light is required, thereby reducing the light intensity in this region, that is, through grayscale modulation control by the DMD, any illumination intensity distribution across the patterned plane can be realized. In addition, an optical path of a coaxial illumination unit 1 can also be enabled or disabled by adjusting on and off of the DMD. In this case, by turning on the off-axis illumination shutter 2-1, the switching from the coaxial illumination unit 1 to an off-axis illumination unit 2 can be achieved.

Based on the above embodiments, S2 further includes: replacing gratings of different sizes and pattern periods, and driving the off-axis illumination unit 2 to move backward and forward by the motion mechanism 2-4, thus realizing the off-axis illumination with different numerical apertures.

A single-pole off-axis illumination unit 2 is adapted to gratings of different pattern periods, and changes of NA of an illumination device can be realized. The motion mechanism 2-4 drives a single-pole off-axis illumination unit 2 to move backward and forward, thereby driving the illumination field to reach a designated position.

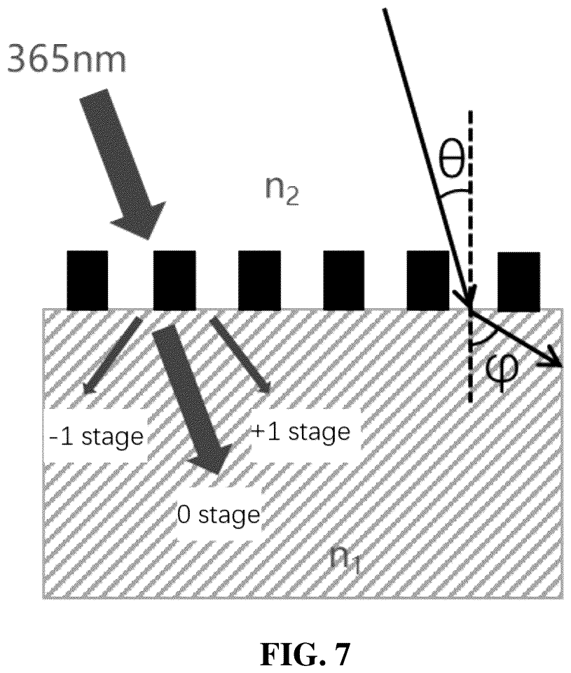

As shown in FIG. 7, the pattern periods of illumination gratings and the NA of the illumination device have a relationship with each other as follows:

$$d ( {n}_{1} sin φ - {n}_{2} sin θ ) = k λ$$

Herein, d represents a required grating period, n₁ represents a refractive index of grating substrate; n₂ represents a refractive index of an incidence surface; φ represents a diffraction angle; θ represents an incidence angle; k represents a diffraction order; and λ represents a wavelength.

$$NA = {n}_{1} sin φ$$

The grating pattern period d can be calculated according to required NA:

$$d = \frac{k λ}{NA - {n}_{2} sin θ}$$

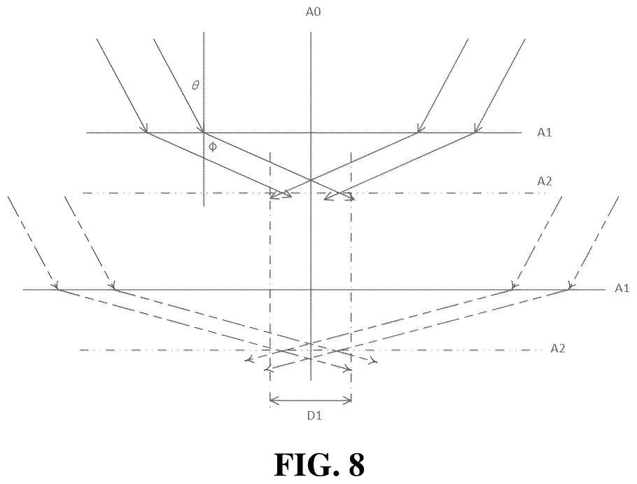

Due to use of the gratings of different pattern periods d, when the numerical aperture NA of the illumination device changes, due to a change in the diffraction angle, if a position of the off-axis illumination unit does not change, a position of the illumination field formed by diffracted light on a patterned plane A2 will change, which results in that when the NA changes, the illumination field fails to be formed in a desired region. In order to form the illumination field in the designated region, such as a region D1 shown in FIG. 8, a single-pole off-axis illumination unit 2 needs to be driven by the motion mechanism 2-4 to move backward and forward, thus forming a desired illumination field. For example, when the NA becomes larger, the diffraction angle φ is increased, in order to enable the illumination field formed in this case and the illumination field formed when the NA is smaller to be both within a range of D1, the motion mechanism 2-4 needs to drive the single-pole off-axis illumination unit 2 to move backward. On the contrary, when the NA becomes smaller, the diffraction angle φ is decreased, in order to enable the illumination field formed in this case and the illumination field formed when the NA is larger to be both within the range of D1, the motion mechanism 2-4 needs to drive the single-pole off-axis illumination unit 2 to move towards a center.

On the basis of the above embodiments, S2 further includes: overlapping light by multiple poles of the off-axis illumination units 2, and selecting a region where the light is overlapped as the illumination field.

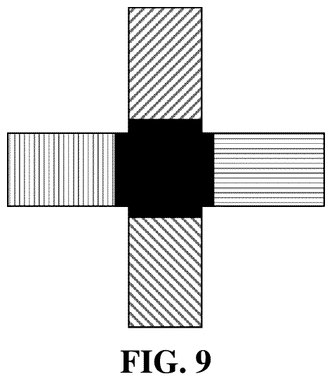

With reference to FIG. 9, since the single-pole off-axis illumination unit 2 has relatively poor light intensity uniformity, multiple poles of the off-axis illumination units 2 are typically used for overlapping light, and an overlap region is selected as the illumination field. As shown in FIG. 9, for example, when the off-axis illumination units 2 are of quadrupole illumination unit, light spots of quadrupole illumination unit are converged on the patterned plane by a displacement motion mechanism 2-4, and a central overlap region is selected as a final illumination field, so as to enhance light intensity uniformity thereof.

In conclusion, the present disclosure provides a coaxial, large-numerical-aperture, multi-pole off-axis illumination device and an illumination method, where when implementing the coaxial illumination, the light field distribution is regulatable; and when implementing the off-axis illumination, a functional requirement for a higher illumination NA angle is met, and the switching between different illumination modes is satisfied.

The above embodiments further describe the objective, technical solutions and beneficial effects of the present disclosure in detail. It should be understood that the above-mentioned are merely for embodiments of the present disclosure, and are not intended to limit the present disclosure. Any amendments, equivalent replacements, improvements and so on made within the spirit and principle of the present disclosure should be covered within the scope of protection of the present disclosure.

1. An illumination device compatible with both coaxial and off-axis configurations, comprising:
a coaxial illumination unit;
N-pole off-axis illumination units;
a substrate, configured to mount the coaxial illumination unit and the N-pole off-axis illumination units; and a motion mechanism, configured to drive the off-axis illumination units to move backward and forward, so as to accommodate gratings of different sizes and pattern periods, thereby achieving illumination with varying numerical apertures.

2. The illumination device compatible with both coaxial and off-axis configurations according to claim 1, wherein the coaxial illumination unit comprises, along an optical path in sequence, a first optical fiber beam expander assembly, a first integrator mirror, a first condenser lens assembly, a total internal reflection mirror, a digital micromirror device and a projection lens assembly, wherein light emitted from an optical fiber is expanded by the first optical fiber beam expander assembly, homogenized by the first integrator mirror and the first condenser lens assembly, and turned by the total internal reflection mirror, to uniformly illuminate the digital micromirror device, intensity-modulated by the digital micromirror device, and then imaged onto a patterned plane by the projection lens assembly.

3. The illumination device compatible with both coaxial and off-axis configurations according to claim 1, wherein the off-axis illumination unit comprises, along an optical path in sequence, an off-axis illumination shutter, a second optical fiber beam expander assembly, a second integrator mirror, a second condenser lens assembly, a first reflector assembly, and a second reflector assembly, wherein light emitted from an optical fiber is expanded by the second optical fiber beam expander assembly, homogenized by the second integrator mirror and the second condenser lens assembly, turned by the first reflector assembly and the second reflector assembly in sequence and then imaged onto a patterned plane; and the off-axis illumination shutter is configured to control the off-axis illumination unit's optical path's on/off state.

4. The illumination device compatible with both coaxial and off-axis configurations according to claim 1, wherein the N-pole off-axis illumination units comprise a single-pole illumination unit, a dipole illumination unit or a quadrupole illumination unit, wherein
when the N is multipoles, the N-pole off-axis illumination units are uniformly distributed around the periphery of the coaxial illumination unit.

5. The illumination device compatible with both coaxial and off-axis configurations according to claim 4, wherein the motion mechanism comprises:
a stage, configured to fix the off-axis illumination units;
a guide rail, fixed on the substrate; and
a motor, configured to push the stage to slide backward and forward on the guide rail.

6. The illumination device compatible with both coaxial and off-axis configurations according to claim 1, wherein an illumination field of the digital micromirror device is provided at a defocused position.

7. A method for illuminating according to the illumination device compatible with both coaxial and off-axis configurations according to claim 1, comprising:
S1, expanding light emitted from an optical fiber by a first optical fiber beam expander assembly, homogenizing expanded light by a first integrator mirror and a first condenser lens assembly, and turning homogenized light by a total internal reflection mirror, to uniformly illuminate the digital micromirror device; performing light intensity modulation by the digital micromirror device, and forming an image on a patterned plane by a projection lens assembly, so as to realize coaxial illumination; and
S2, expanding the light emitted from the optical fiber by a second optical fiber beam expander assembly, homogenizing expanded light by a second integrator mirror and a second condenser lens assembly, turning homogenized light by a first reflector assembly and a second reflector assembly in sequence, and then forming an image on the patterned plane, so as to realize off-axis illumination, wherein
switching between the coaxial illumination and the off-axis illumination is achieved by the digital micromirror device and an off-axis illumination shutter.

8. The method for illuminating according to the illumination device compatible with both coaxial and off-axis configurations according to claim 7, wherein the S1 further comprises:
performing grayscale modulation control by the digital micromirror device, so as to achieve any illumination intensity distribution across an illumination field.

9. The method for illuminating according to the illumination device compatible with both coaxial and off-axis configurations according to claim 7, wherein the S2 further comprises:
replacing gratings of different sizes and pattern periods, and driving the off-axis illumination unit to move backward and forward by the motion mechanism, so as to achieve the off-axis illumination with varying numerical apertures.

10. The method for illuminating according to the illumination device compatible with both coaxial and off-axis configurations according to claim 9, wherein the S2 further comprises:
overlapping light by multipole off-axis illumination units, and selecting a region where the light is overlapped as an illumination field.

11-15. (canceled)
